(19) United States
(12) Patent Application Publication
(10) Pub. No.: US 2018/0051911 A1
(43) Pub. Date: Feb. 22, 2018

(54) WATER HEATER APPLIANCE

(71) Applicant: Haier US Appliance Solutions, Inc., Wilmington, DE (US)

(72) Inventors: Timothy Scott Shaffer, La Grange, KY (US); Shaun Michael Ward, Louisville, KY (US)

(21) Appl. No.: 15/239,890

(22) Filed: Aug. 18, 2016

(51) Int. Cl. F24H 9/12; F24H 1/18; G05D 23/19

(52) U.S. Cl. CPC F24H 9/124; G05D 23/19; F24H 1/18

(57) ABSTRACT

A water heater appliance defining a vertical direction and a horizontal direction is provided. The water heater appliance includes a side that extends along the vertical direction between a top and a bottom of the water heater appliance. The water heater appliance includes a heated water conduit and a cold water conduit extending from the side substantially along the horizontal direction. A mixing valve has a heated water inlet that shares a common axis with the heated water conduit. A bypass conduit extends substantially along the vertical direction between the cold water conduit and a cold water inlet to the mixing valve. In this manner, the mixing valve may be quickly and easily interchangeable within the water heater appliance without requiring the rerouting or manipulation of the existing plumbing.

### FIELD OF THE INVENTION

The present subject matter relates generally to water heater appliances, and more particularly, to mixing valve and plumbing configurations for water heater appliances.

### BACKGROUND OF THE INVENTION

Certain water heater appliances include a tank therein. Heating elements, such as gas burners, electric resistance elements, or sealed systems, heat water within the tank during operation of such water heater appliances. In particular, the heating elements generally heat water within the tank to a predetermined temperature. The predetermined temperature is generally selected such that heated water within the tank is suitable for showering, washing hands, etc.

During operation, relatively cool water flows into the tank, and the heating elements operate to heat such water to the predetermined temperature. Thus, the volume of heated water available at the predetermined temperature is generally limited to the volume of the tank. Accordingly, water heater appliances are sold in various sizes to permit consumers to select a proper tank volume and provide sufficient heated water. However, large water heater appliances with large tanks occupy large amount of space within a residence or business. In certain buildings, space is limited and/or expensive. Thus, utilizing large water heater appliances can be impractical and/or prohibitively expensive despite needing large volumes of heated water.

To provide relatively large volumes of heated water from relatively small tanks, certain water heater appliances utilize a mixing valve. The mixing valve permits water within the water heater's tank to be stored at relatively high temperatures. The mixing valve mixes such high temperature water with relatively cool water in order to bring the temperature of such water down to suitable and/or more usable temperatures. Thus, such water heater appliance can provide relatively large volumes of heated water without requiring large tanks.

Many conventional water heater appliances have hot and cold water conduits that extend from a side of the water heater appliance to connect to a mixing valve. Fluidly coupling conventional mixing valves with such side mounted water conduits often requires rerouting the plumbing and/or reorienting the mixing valve. Such plumbing adjustments require additional parts and labor, thus increasing maintenance and repair times and costs. Furthermore, additional space adjacent the water heater appliance may be required to accommodate the additional plumbing.

Accordingly, a water heater appliance having a mixing valve that includes features for simplifying installation into the water heater appliance would be useful. More specifically, a water heater appliance having a mixing valve that includes water inlet conduits that align with existing water heater conduits would be particularly beneficial.

### BRIEF DESCRIPTION OF THE INVENTION

The present subject matter provides a water heater appliance defining a vertical direction and a horizontal direction. The water heater appliance includes a side that extends along the vertical direction between a top and a bottom of the water heater appliance. The water heater appliance includes a heated water conduit and a cold water conduit extending from the side substantially along the horizontal direction. A mixing valve has a heated water inlet that shares a common axis with the heated water conduit. A bypass conduit extends substantially along the vertical direction between the cold water conduit and a cold water inlet to the mixing valve. In this manner, the mixing valve may be quickly and easily interchangeable within the water heater appliance without requiring the rerouting or manipulation of the existing plumbing. Additional aspects and advantages of the invention will be set forth in part in the following description, or may be apparent from the description, or may be learned through practice of the invention.

In a first exemplary embodiment, a water heater appliance defining an axial direction and a radial direction is provided. The water heater appliance includes a casing and a tank disposed within the casing. The tank defines an interior volume and includes a side that extends along the axial direction between a top of the tank and a bottom of the tank. A cold water conduit extends from the side of the tank substantially along the radial direction, the cold water conduit being configured for directing water into the interior volume of the tank. A heated water conduit extends from the side of the tank substantially along the radial direction, the heated water conduit being configured for directing water out of the interior volume of the tank. A bypass conduit extends from the cold water conduit. A mixing valve includes a heated water inlet fluidly coupled to the heated water conduit and a cold water inlet fluidly coupled to the bypass conduit, the mixing valve being configured for selectively mixing water from the heated water conduit and water from the bypass conduit to provide mixed water to a mixed water conduit, the heated water inlet sharing a common axis with the heated water conduit.

In a second exemplary embodiment, a mixing valve for a water heater appliance is provided. The water heater appliance defines a vertical direction and a horizontal direction and includes a cold water conduit and a heated water conduit extending along the horizontal direction. The mixing valve includes a valve body defining a heated water inlet, a cold water inlet, and a mixed water outlet, the heated water inlet extending along the horizontal direction and sharing a common axis with the heated water conduit, and the cold water inlet extending perpendicular to the heated water inlet.

In a third exemplary embodiment, a water heater appliance defining a vertical direction and a horizontal direction is provided. The water heater appliance includes a tank including a side that extends along the vertical direction between a top of the tank and a bottom of the tank. A cold water conduit extends from the side of the tank along a first axis, a heated water conduit extends from the side of the tank along a second axis, and a bypass conduit extends from the cold water conduit. A mixing valve includes a heated water inlet, a cold water inlet, and a mixed water outlet, the heated water inlet extending along the second axis.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a water heater appliance according to an exemplary embodiment of the present subject matter.

FIG. 2 provides a schematic view of certain components of the exemplary water heater appliance of FIG. 1 and an electronic mixing valve according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

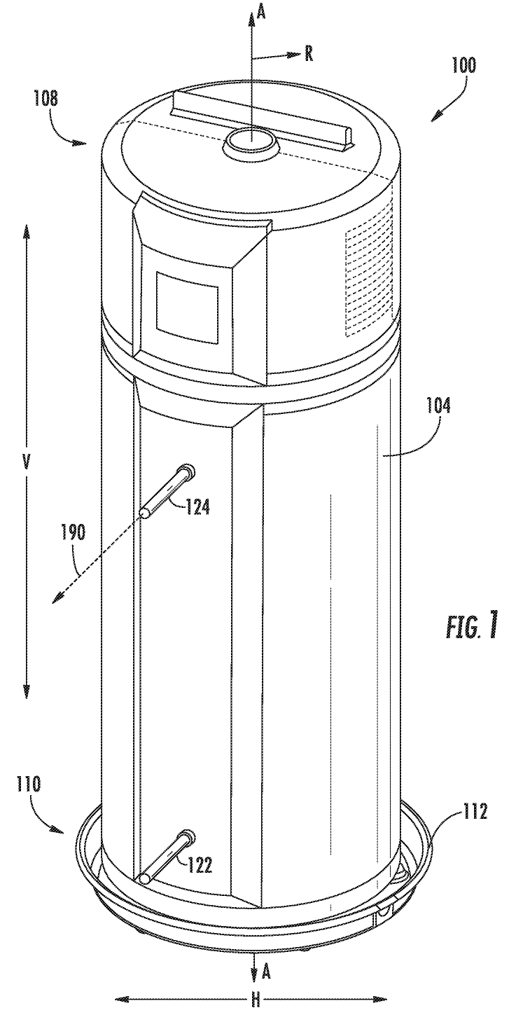

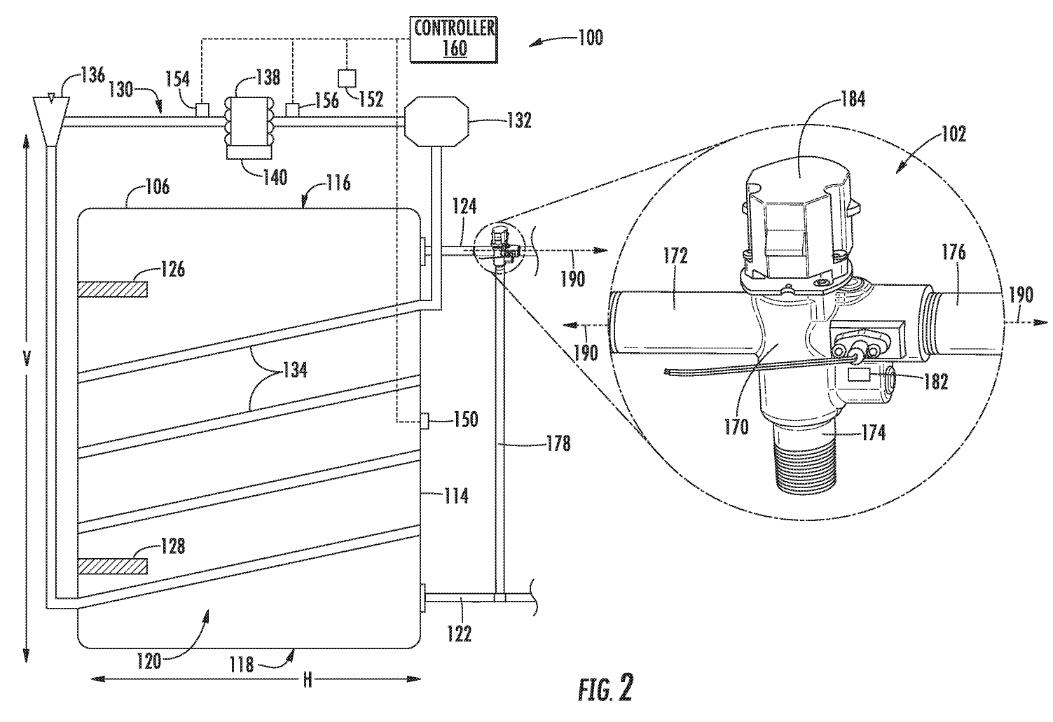

FIG. 1 provides a perspective view of a water heater appliance 100 according to an exemplary embodiment of the present subject matter. FIG. 2 provides a schematic view of certain components of water heater appliance 100 including an exemplary mixing valve 102, as will be described in detail below. As may be seen in FIGS. 1 and 2, water heater appliance 100 includes a casing 104 and a tank 106 mounted within casing 104.

As may be seen in FIG. 1, water heater appliance 100 generally defines an axial direction A and a radial direction R. According to the illustrated exemplary embodiment, when water heater appliance is installed, the axial direction A corresponds to a vertical direction V and the radial direction R corresponds to a horizontal direction H. Thus, water heater appliance 100 is generally vertically oriented. Water heater appliance 100 can be leveled, e.g., such that casing 104 is plumb in the vertical direction V, in order to facilitate proper operation of water heater appliance 100.

Casing 104 extends between a top portion 108 and a bottom portion 110 along a vertical direction V. A drain pan 112 is positioned at bottom portion 110 of water heater appliance 100 such that water heater appliance 100 sits on drain pan 112. Drain pan 112 sits beneath water heater appliance 100 along the vertical direction V, e.g., to collect water that leaks from water heater appliance 100 or water that condenses on an evaporator 138 (discussed below) of water heater appliance 100. It should be understood that water heater appliance 100 is provided by way of example only and that the present subject matter may be used with any suitable water heater appliance.

Turning now to FIG. 2, tank 106 includes a side wall 114 that extends along the axial direction A between a top portion 116 and a bottom portion 118 of tank 106. According to the illustrated embodiment, tank 106 is cylindrically shaped. However, it should be appreciated that tank 106 could be any suitable shape, such as rectangular, elliptical, etc. Tank 106 generally defines an interior volume 120 for heating water therein. Water heater appliance 100 also includes a cold water conduit 122 and a heated water conduit 124 that are both in fluid communication with tank 120 within casing 104. As an example, cold water from a water source, e.g., a municipal water supply or a well, enters water heater appliance 100 through cold water conduit 122. From cold water conduit 122, such cold water enters interior volume 120 of tank 106 wherein the water is heated to generate heated water. Such heated water exits water heater appliance 100 at heated water conduit 124 and, e.g., is supplied to a bath, shower, sink, or any other suitable feature.

As may be seen in FIG. 2, cold water conduit 122 is mounted to tank 106 at or adjacent bottom portion 118 of tank 106. In addition, heated water conduit 124 is mounted to tank 106 at or adjacent top portion 116 of tank 106. Thus, cold water conduit 122 and heated water conduit 124 are spaced apart from each other on tank 106, e.g., along the vertical direction V. Cold water conduit 122 and heated water conduit 124 extend from side wall 114 of tank 106. For this reason, water heater appliance 100 may be referred to as a “side-mounted” water heater. It should be appreciated, however, that aspects of the present subject matter may apply to any suitable water heater appliance.

Water heater appliance 100 includes an upper heating element 126, a lower heating element 128 and a sealed system 130 for heating water within interior volume 120 of tank 106. Thus, water heater appliance 100 is commonly referred to as a “heat pump water heater appliance.” Upper and lower heating elements 126 and 128 can be any suitable heating elements. For example, upper heating element 126 and/or lower heating element 128 may be an electric resistance element, a microwave element, an induction element, or any other suitable heating element or combination thereof. Lower heating element 126 may also be a gas burner.

Sealed system 130 includes a compressor 132, a condenser 134, a throttling device 136 and an evaporator 138. Condenser 134 is thermally coupled or assembled in a heat exchange relationship with tank 106 in order to heat water within interior volume 120 of tank 106 during operation of sealed system 130. In particular, condenser 134 may be a conduit coiled around and mounted to tank 106. During operation of sealed system 130, refrigerant exits evaporator 138 as a fluid in the form of a superheated vapor and/or high quality vapor mixture. Upon exiting evaporator 138, the refrigerant enters compressor 132 wherein the pressure and temperature of the refrigerant are increased such that the refrigerant becomes a superheated vapor. The superheated vapor from compressor 132 enters condenser 134 wherein it transfers energy to the water within tank 106 and condenses into a saturated liquid and/or high quality liquid vapor mixture. This high quality/saturated liquid vapor mixture exits condenser 134 and travels through throttling device 136 that is configured for regulating a flow rate of refrigerant therethrough. Upon exiting throttling device 136, the pressure and temperature of the refrigerant drop at which time the refrigerant enters evaporator 138 and the cycle repeats itself. In certain exemplary embodiments, throttling device 136 may be an electronic expansion valve (EEV).

A fan or air handler 140 may assist with heat transfer between air about water heater appliance 100, e.g., within casing 104, and refrigerant within evaporator 138. Air handler 140 may be positioned within casing 104 on or adjacent evaporator 138. Thus, when activated, air handler 140 may direct a flow of air towards or across evaporator 138, and the flow of air from air handler 140 may assist with heating refrigerant within evaporator 138. Air handler 140 may be any suitable type of air handler, such as an axial or centrifugal fan.

Water heater appliance 100 also includes a tank temperature sensor 150. Tank temperature sensor 150 is configured for measuring a temperature of water within interior volume 120 of tank 106. Tank temperature sensor 150 can be positioned at any suitable location within or on water heater appliance 100. For example, tank temperature sensor 150 may be positioned within interior volume 120 of tank 106 or may be mounted to tank 106 outside of interior volume 120 of tank 106. When mounted to tank 106 outside of interior volume 120 of tank 106, tank temperature sensor 150 can be configured for indirectly measuring the temperature of water within interior volume 120 of tank 106. For example, tank temperature sensor 150 can measure the temperature of tank 106 and correlate the temperature of tank 106 to the temperature of water within interior volume 120 of tank 106. Tank temperature sensor 150 may also be positioned at or adjacent top portion 116 of tank 106, e.g., at or adjacent an inlet of heated water conduit 124.

Tank temperature sensor 150 can be any suitable temperature sensor. For example, tank temperature sensor 150 may be a thermocouple or a thermistor. As may be seen in FIG. 2, tank temperature sensor 150 may be the only temperature sensor positioned at or on tank 106 that is configured for measuring the temperature of water within interior volume 120 of tank 106 in certain exemplary embodiments. In alternative exemplary embodiments, additional temperature sensors may be positioned at or on tank 106 to assist tank temperature sensor 150 with measuring the temperature of water within interior volume 120 of tank 106, e.g., at other locations within interior volume 120 of tank 106.

Water heater appliance 100 also includes an ambient temperature sensor 152, an evaporator inlet temperature sensor 154, and an evaporator outlet temperature sensor 156. Ambient temperature sensor 152 is configured for measuring a temperature of air about water heater appliance 100. Ambient temperature sensor 152 can be positioned at any suitable location within or on water heater appliance 100. For example, ambient temperature sensor 152 may be mounted to casing 104, e.g., at or adjacent top portion 108 of water heater appliance 100. Ambient temperature sensor 152 can be any suitable temperature sensor. For example, ambient temperature sensor 152 may be a thermocouple or a thermistor.

Evaporator inlet temperature sensor 154 is configured for measuring a temperature of refrigerant at or adjacent inlet of evaporator 138. Thus, evaporator inlet temperature sensor 154 may be positioned at or adjacent inlet of evaporator 138, as shown in FIG. 2. For example, evaporator inlet temperature sensor 154 may be mounted to tubing that directs refrigerant into evaporator 138, e.g., at or adjacent inlet of evaporator 138. When mounted to tubing, evaporator inlet temperature sensor 154 can be configured for indirectly measuring the temperature of refrigerant at inlet of evaporator 138. For example, evaporator inlet temperature sensor 154 can measure the temperature of the tubing and correlate the temperature of the tubing to the temperature of refrigerant at inlet of evaporator 138. Evaporator inlet temperature sensor 154 can be any suitable temperature sensor. For example, evaporator inlet temperature sensor 154 may be a thermocouple or a thermistor.

Evaporator outlet temperature sensor 156 is configured for measuring a temperature of refrigerant at or adjacent outlet of evaporator 138. Thus, evaporator outlet temperature sensor 156 may be positioned at or adjacent outlet of evaporator 138, as shown in FIG. 2. For example, evaporator outlet temperature sensor 156 may be mounted to tubing that directs refrigerant out of evaporator 138, e.g., at or adjacent outlet of evaporator 138. When mounted to tubing, evaporator outlet temperature sensor 156 can be configured for indirectly measuring the temperature of refrigerant at outlet of evaporator 138. For example, evaporator outlet temperature sensor 156 can measure the temperature of the tubing and correlate the temperature of the tubing to the temperature of refrigerant at outlet of evaporator 138. Evaporator outlet temperature sensor 156 can be any suitable temperature sensor. For example, evaporator outlet temperature sensor 156 may be a thermocouple or a thermistor.

Water heater appliance 100 further includes a controller 160 that is configured for regulating operation of water heater appliance 100. Controller 160 is in, e.g., operative, communication with upper heating element 126, lower heating element 128, compressor 132, tank temperature sensor 150, ambient temperature sensor 152, evaporator inlet temperature sensor 154, evaporator outlet temperature sensor 156, and air handler 140. Thus, controller 160 may selectively activate upper and lower heating elements 126 and 128 and/or compressor 132 in order to heat water within interior volume 120 of tank 106, e.g., in response to signals from tank temperature sensor 150, ambient temperature sensor 152, evaporator inlet temperature sensor 154, and/or evaporator outlet temperature sensor 156.

Controller 160 includes memory and one or more processing devices such as microprocessors, CPUs or the like, such as general or special purpose microprocessors operable to execute programming instructions or micro-control code associated with operation of water heater appliance 100. The memory can represent random access memory such as DRAM, or read only memory such as ROM or FLASH. The processor executes programming instructions stored in the memory. The memory can be a separate component from the processor or can be included onboard within the processor. Alternatively, controller 160 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 160 may operate upper heating element 126, lower heating element 128 and/or compressor 132 in order to heat water within interior volume 120 of tank 106. As an example, a user may select or establish a set temperature, tₛ, for water within interior volume 120 of tank 106, or the set temperature tₛ for water within interior volume 120 of tank 106 may be a default value. Based upon the set temperature tₛ for water within interior volume 120 of tank 106, controller 160 may selectively activate upper heating element 126, lower heating element 128, and/or compressor 132 in order to heat water within interior volume 120 of tank 106 to the set temperature tₛ for water within interior volume 120 of tank 106. The set temperature tₛ for water within interior volume 120 of tank 106 may be any suitable temperature. For example, the set temperature tₛ for water within interior volume 120 of tank 106 may be between about one hundred degrees Fahrenheit and about one hundred and eighty-degrees Fahrenheit. As used herein with regards to temperature approximations, the term “about” means within ten degrees of the stated temperature.

Referring still to FIG. 2, water heater appliance 100 also includes a mixing valve 102 for selectively mixing water from cold water conduit 122 and water from heated water conduit 124 to provide mixed water at the desired temperature. Mixing valve generally includes a valve body 170, a heated water inlet 172, a cold water inlet 174, and a mixed water conduit 176. Mixing valve 102 is in fluid communication with heated water conduit 124 via heated water inlet 172. In addition, a bypass conduit 178 places cold water inlet 174 in fluid communication with cold water conduit 122. Accordingly, heated water from interior volume 120 of tank 106 may flow into a mixing chamber of valve body 170 via heated water conduit 124, and cold water from cold water conduit 122 may flow into the mixing chamber of valve body 170 via bypass conduit 178. As discussed in greater detail below, mixing valve 102 is configured for selectively directing water from cold water conduit 122 and heated water conduit 124 into mixed water conduit 176 in order to regulate a temperature of water within mixed water conduit 176.

As an example, mixing valve 102 can selectively adjust between a first position and a second position. In the first position, mixing valve 102 can permit a first flow rate of relatively cool water from cold water conduit 122 and a first flow rate of relatively hot water from heated water conduit 124 into mixed water conduit 176. In such a manner, based on the ratio of hot and cold water, the mixed water within mixed water conduit 176 can have a first particular temperature when mixing valve 102 is in the first position. Similarly, in the second position, mixing valve 102 can permit a second flow rate of relatively cool water from cold water conduit 122 and a second flow rate of relatively hot water from heated water conduit 124 into mixed water conduit 176. The first and second flow rates of the relatively cool water and relatively hot water are different such that water within mixed water conduit 176 can have a second particular temperature when mixing valve 102 is in the second position. In such a manner, mixing valve 102 can regulate the temperature of water within mixed water conduit 176 and adjust the temperature of water within mixed water conduit 176 between the first and second particular temperatures.

It should be understood that, in certain exemplary embodiments, mixing valve 102 is adjustable between more positions than the first and second positions. In particular, mixing valve 102 may be adjustable between any suitable number of positions in alternative exemplary embodiments. For example, mixing valve 102 may be infinitely adjustable in order to permit fine-tuning of the temperature of water within mixed water conduit 176.

Valve body 170 may be formed such that heated water inlet 172, cold water inlet 174, and mixed water conduit 176 of valve body 170 are integrally formed with one another. Thus, e.g., valve body 170 may be cast from a suitable metal, such as steel, aluminum, bronze, etc. Valve body 170 may also be formed of any other suitable rigid and/or ductile material, such as a plastic, a composite, etc., that is suitable for shipping and installing water heater appliance 100 without fracturing valve body 170.

Water heater appliance 100 also includes a position sensor 182. Position sensor 182 is configured for determining a position of mixing valve 102. Position sensor 182 can monitor the position of mixing valve 102 in order to assist with regulating the temperature of water within mixed water conduit 176. For example, position sensor 182 can determine when mixing valve 102 is in the first position or the second position in order to ensure that mixing valve 102 is properly or suitably positioned depending upon the temperature of water within mixed water conduit 176 desired or selected. Thus, position sensor 182 can provide feedback regarding the status or position of mixing valve 102.

Position sensor 182 may be any suitable type of sensor. For example, position sensor 182 may be a physical sensor, such as an optical sensor, Hall-effect sensor, etc. In alternative exemplary embodiments, water heater appliance 100 need not include position sensor 182, and controller 160 may determine or measure a motor position of mixing valve 102 based on a previously commanded position of mixing valve 102. Thus, controller 160 may determine that the current position of mixing valve 102 corresponds to a latest position that controller 160 commanded for mixing valve 102 in a previous iteration.

Controller 160 can also operate mixing valve 102 to regulate the temperature of water within mixed water conduit 176. For example, controller 160 can adjust the position of mixing valve 102 in order to regulate the temperature of water within mixed water conduit 176. As an example, a user can select or establish a set-point temperature of mixing valve 102, or the set-point temperature of mixing valve 102 may be a default value. Based upon the set-point temperature of mixing valve 102, controller 160 can adjust the position of mixing valve 102 in order to change or tweak a ratio of relatively cool water flowing into mixed water conduit 176 from cold water conduit 122 and relatively hot water flowing into mixed water conduit 176 from heated water conduit 124. In such a manner, controller 160 can regulate the temperature of water within mixed water conduit 176.

The set-point temperature of mixing valve 102 can be any suitable temperature. For example, the set-point temperature of mixing valve 102 may be between about one hundred degrees Fahrenheit and about one hundred and twenty degrees Fahrenheit. In particular, the set-point temperature of mixing valve 102 may be selected such that the set-point temperature of mixing valve 102 is less than the set-point temperature for water within interior volume 120 of tank 106. In such a manner, mixing valve 102 can utilize water from cold water conduit 122 and heated water conduit 124 to regulate the temperature of water within mixed water conduit 176.

Water heater appliance 100 may also include one or more temperature sensors for measuring the temperature of water at various locations within water heater appliance 100. For example, temperature sensors may be placed in tank 106, cold water conduit 122, heated water conduit 124, mixed water conduit 176, bypass conduit 178, etc. Temperature measurements from these temperature sensors can be used by controller 160 to operate water heater appliance 100, e.g., by ensuring the water in mixed water conduit 176 matches the set-point temperature.

Mixing valve 102 further includes a motor 184, such as a stepper motor. Thus, mixing valve 102 is generally referred to as an “electronic mixing valve.” Motor 184 is coupled to a plunger (not shown) within valve body 170, and motor 184 is operable to adjust a position of the plunger within valve body 170. As an example, the plunger may be positioned such that the plunger blocks or significantly limits fluid flow from heated water inlet 172 of valve body 170 when the plunger is in a fully open position. Thus, all or most of water flowing to mixed water conduit 176 of valve body 170 is from cold water inlet 174, and water within mixed water conduit 176 of valve body 170 is at or about the temperature of water within cold water inlet 174 when the plunger is in the fully open position. Conversely, the plunger may be positioned such that the plunger blocks or significantly limits fluid flow from cold water inlet 174 of valve body 170 when the plunger is in a fully closed position. Thus, all or most of water flowing to mixed water conduit 176 of valve body 170 is from heated water inlet 172 and water within mixed water conduit 176 of valve body 170 is at or about the temperature of water within heated water inlet 172 when the plunger is in the fully closed position.

Motor 184 may adjust the plunger between the open and closed positions. In addition, motor 184 may adjust the plunger to any suitable position between the open and closed positions. In such a manner, motor 184 may adjust the temperature of water exiting mixing valve 102 at mixed water conduit 176 of valve body 170 to any suitable temperature between the temperature of water within cold water inlet 174 and the temperature of water within heated water inlet 172.

Although mixing valve 102 described above is an electronic mixing valve, it should be appreciated that mixing valve 102 is only used for the purpose of explaining aspects of the present subject matter. Other types and configurations of mixing valves may be used. For example, mixing valve 102 may be a thermostatic mixing valve such that mixing valve 102 automatically adjusts a mixing ratio of mixing valve 102. Indeed, mixing valve 102 may be any device suitable for mixing two fluid streams, i.e., for mixing liquid from heated water conduit 124 with liquid from bypass conduit 178.

According to some embodiments, mixing valve 102 may also include a thermal safety sensor (not shown). The thermal safety sensor may be any suitable type of temperature sensor or switch. For example, the thermal safety sensor may be a bimetal switch, a thermal cutoff (TCO), a thermistor, a thermocouple, etc. The thermal safety sensor may be in communication with controller 160, e.g., such that controller 160 deactivates compressor 132, upper heating element 126 and/or lower heating element 128 when temperature measurements from the thermal safety sensor exceed a temperature limit. As another example, thermal safety sensor may be directly wired to compressor 132, upper heating element 126, and/or lower heating element 128, e.g., such that the thermal safety sensor interrupts power supply to compressor 132, upper heating element 126 and/or lower heating element 128 when temperature measurements from the thermal safety sensor exceed the temperature limit. The temperature limit may be any suitable temperature. For example, the temperature limit may be one-hundred and forty degrees Fahrenheit, one-hundred and fifty degrees Fahrenheit, one-hundred and sixty degrees Fahrenheit, etc. As another example, the temperature limit may be selected such that the temperature limit is greater than the set temperature of mixing valve 102 and less than the set temperature tₛ for water within interior volume 120 of tank 106. The thermal safety sensor may positioned downstream of mixing valve 102 on mixed water conduit 176 or at any other suitable location within water heater appliance 100. Moreover, thermal safety sensor may be positioned on a thermal mass to assist with avoiding nuisance tripping of the thermal safety sensor, e.g., when temperature measurements from thermal safety sensor 230 momentarily or briefly exceed the temperature limit.

According to the illustrated exemplary embodiment, heated water conduit 124 shares a common axis 190, such as a common central axis, with heated water inlet 172 of mixing valve 102. More specifically, heated water conduit 124 extends from tank 106 substantially along the radial direction R and defines common axis 190. As used herein, when used to specify a directional orientation, “substantially” is intended to refer to within ten degrees of the stated direction. Similarly, when mixing valve 102 is mounted to heated water conduit 124, e.g., by screwing or gluing heated water inlet 172 to heated water conduit 124, heated water inlet 172 extends along common axis 190. In this manner, heated water conduit 124 and heated water inlet 172 of valve body 170 may be positioned coaxially with each other, and may both extend horizontally within casing 104 of water heater appliance 100. In addition, according to an exemplary embodiment, mixed water conduit 176 may also be coaxial with heated water conduit 124 and heated water inlet 172 such that it extends along common axis 190 in the horizontal direction H.

In addition, cold water inlet 174 of valve body 170 may be oriented such that cold water inlet 174 extends orthogonally to heated water inlet 172 and mixed water conduit 176 of valve body 170. In this manner, heated water conduit 124, cold water conduit 122, bypass conduit 178, and heated water inlet 172 extend along or are disposed within a plane defined by the axial direction A and common axis 190 of heated water conduit 124. Such an arrangement of heated water inlet 172, cold water inlet 174, and mixed water conduit 176 of valve body 170 may assist with preserving valuable volume within casing 104 of water heater appliance 100. In particular, such arrangement of heated water inlet 172, cold water inlet 174, and mixed water conduit 176 of valve body 170 may assist with limiting an area occupied by mixing valve 102, e.g., in a plane that is perpendicular to the vertical direction V, while allowing easy access to mixing valve 102 within casing 104.

According to the exemplary embodiment, mixing valve 102 may be positioned or disposed within casing 104 of water heater appliance 100, e.g., adjacent top portion 116 of tank 106, such that mixing valve 102 is integrated within water heater appliance 100. Similarly, bypass conduit 178 may extend perpendicular to cold water conduit 122 along the vertical direction within casing 104. However, it should be appreciated that according to alternative embodiments, mixing valve 102, bypass conduit 178, and other components of water heater appliance 100 may be positioned outside casing 104, or at any other suitable location.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A water heater appliance defining an axial direction and a radial direction, the water heater appliance comprising:
a casing;
a tank disposed within the casing, the tank defining an interior volume and comprising a side wall that extends along the axial direction between a top portion of the tank and a bottom portion of the tank;
a cold water conduit extending from the side wall of the tank substantially along the radial direction, the cold water conduit being configured for directing water into the interior volume of the tank;
a heated water conduit extending from the side wall of the tank substantially along the radial direction, the heated water conduit being configured for directing water out of the interior volume of the tank;
a mixing valve comprising a heated water inlet coupled to the heated water conduit and a cold water inlet; and
a bypass conduit extending between the cold water conduit and the cold water inlet of the mixing valve, wherein the mixing valve is configured for selectively mixing water from the heated water conduit and water from the bypass conduit to provide mixed water to a mixed water conduit, and wherein the heated water conduit, the heated water inlet, and the mixed water conduit share a common axis.

2. The water heater appliance of claim 1, wherein the bypass conduit is oriented perpendicular to the cold water conduit.

3. (canceled)

4. The water heater appliance of claim 1, wherein the heated water conduit, the cold water conduit, the bypass conduit, and the heated water inlet are disposed within a plane defined by the axial direction and the common axis of the heated water conduit.

5. The water heater appliance of claim 1, wherein the heated water conduit is positioned proximate the top portion of the tank and the cold water conduit is positioned proximate the bottom portion of the tank.

6. The water heater appliance of claim 1, wherein the mixing valve is positioned within the casing adjacent the side wall of the tank and proximate the top portion of the tank.

7. The water heater appliance of claim 1, wherein the bypass conduit extends along the axial direction within the casing between the cold water conduit and the cold water inlet.

8. The water heater appliance of claim 1, wherein the mixing valve is an electronic mixing valve.

9. The water heater appliance of claim 1, further comprising a sealed system operable to heat water within the interior volume of the tank, the sealed system comprising an evaporator and a compressor positioned within the casing at a top portion of the casing above the tank.

10. A mixing valve for a water heater appliance, the water heater appliance defining a vertical direction and a horizontal direction and comprising a cold water conduit and a heated water conduit extending along the horizontal direction, the mixing valve comprising:
a valve body defining a heated water inlet, a cold water inlet, and a mixed water outlet, the heated water inlet extending along the horizontal direction and sharing a common axis with the heated water conduit and the mixed water outlet, and the cold water inlet extending perpendicular to the heated water inlet; and
a bypass conduit, the bypass conduit extending perpendicular to the cold water conduit along the vertical direction, the bypass conduit fluidly coupling the cold water conduit and the cold water inlet.

11. (canceled)

12. The mixing valve of claim 10, wherein the bypass conduit extends along the vertical direction within a casing of the water heater appliance.

13. (canceled)

14. The mixing valve of claim 10, wherein the heated water conduit, the cold water conduit, and the heated water inlet extend along a plane defined by the vertical direction and the common axis of the heated water conduit.

15. The mixing valve of claim 10, wherein the water heater appliance further comprises a tank disposed within a casing and defining an interior volume, the tank comprising a side wall that extends along the vertical direction between a top portion and a bottom portion,
wherein the heated water conduit is positioned proximate the top portion of the tank and the cold water conduit is positioned proximate the bottom portion of the tank.

16. The mixing valve of claim 15, wherein the mixing valve is positioned within the casing adjacent the side wall of the tank proximate the top portion of the tank.

17. The mixing valve of claim 10, wherein the mixing valve is an electronic mixing valve.

18. The mixing valve of claim 10, wherein the water heater appliance further comprises a sealed system operable to heat water within the water heater appliance, the sealed system comprising an evaporator and a compressor positioned within the water heater appliance.

19. A water heater appliance defining a vertical direction and a horizontal direction, the water heater appliance comprising:
a tank comprising a side wall that extends along the vertical direction between a top portion of the tank and a bottom portion of the tank;
a cold water conduit extending from the side wall of the tank along a first axis;
a heated water conduit extending from the side wall of the tank along a second axis;
a mixing valve comprising a heated water inlet, a cold water inlet, and a mixed water outlet, the heated water inlet and the mixed water outlet extending along the second axis; and
a bypass conduit extending between the cold water conduit and the cold water inlet of the mixing valve.

20. The water heater appliance of claim 19, wherein the first axis and the second axis extend along the horizontal direction and the bypass conduit extends along the vertical direction to fluidly couple the cold water conduit and the cold water inlet.
